(19) United States
(12) Patent Application Publication
(10) Pub. No.: US 2011/0307086 A1
(43) Pub. Date: Dec. 15, 2011

(54) METHOD, APPARATUS AND RECORDING MEDIUM FOR PLAYING SOUND SOURCE

(75) Inventor: Bong Gun Shin, Seoul (KR)

(73) Assignee: PENTAVISION CO., LTD, Seongnam-si (KR)

(21) Appl. No.: 13/151,934

(22) Filed: Jun. 2, 2011

(30) Foreign Application Priority Data
Jun. 10, 2010 (KR) 10-2010-0054649

(51) Int. Cl. G06F 17/00

(52) U.S. Cl. 700/94

(57) ABSTRACT

Disclosed is a method, an apparatus and a recording medium for playing back a sound source. The method, the apparatus and the recording medium for playing back a sound source, selectively play back various sound sources according to a user's operations, and then provide various effects produced by using the selectively played-back sound sources, in an application such as a game or the like.

### CROSS-REFERENCE TO RELATED APPLICATION

This application claims priority from and the benefit under 35 U.S.C. §119(a) of Korean Patent Application No. 10-2010-0054649, filed on Jun. 10, 2010, which is hereby incorporated by reference for all purposes as if fully set forth herein.

### BACKGROUND OF THE INVENTION

1. Field of the Invention

The present invention relates to a method, an apparatus and a recording medium for playing back a sound source, and more particularly to a method, an apparatus and a recording medium for playing back a sound source, which selectively play back various sound sources according to a user's operations and then provide various effects produced by using the selectively played-back sound sources, in an application such as a game or the like.

2. Description of the Prior Art

Conventionally, an application (i.e. a game or the like) causes different sound sources to be played back according to results of a user's operations, and then provides various effects produced by using the different played-back sound sources. In order to provide the various effects produced by using the different played-back sound sources, it is required to separately store the sound sources corresponding to the results of the user's operations.

Also, conventionally, the many different sound sources according to the results of the user's operations are prepared, and each sound source is played back in the form of overlaying the many prepared sound sources on top of each other. Then, the various effects produced by using the played-back sound sources are provided. In the conventional scheme for providing the various effects produced by using the sound sources in the form of superimposing another sound source onto an originally played-back sound source as described above, multiple sound channels equal to the number of prepared sound sources may be required, and a terminal requires hardware thereof to have high-performance in processing and outputting the many prepared sound sources.

However, a terminal (e.g. a mobile terminal), which has a single sound channel or fewer sound channels than the number of the sound sources, or has a relatively low performance in processing and outputting the sound sources, has a problem such that it cannot provide the various effects produced by using the many different sound sources in the conventional scheme for playing back each sound source in the form of overlaying the many different sound sources, which are prepared according to the results of the user's operations, on top of each other.

### SUMMARY OF THE INVENTION

Accordingly, the present invention has been made to solve the above-mentioned problems occurring in the prior art, and an object of the present invention is to provide a method, an apparatus and a recording medium for playing back a sound source, by which various effects produced by using sound sources according to a user's operations of an application (e.g. a game or the like) can be provided in the application by using only a minimum number of sound sources.

Also, another object of the present invention is to provide a method, an apparatus and a recording medium for playing back a sound source, which provide effects similar to those, which are produced by using sound sources played back in the form of overlaying the sound sources on top of each other, by selectively changing a sound source to another sound source and then playing back the changed sound source whenever sound source playback control information is input, even in an application (e.g. a mobile game) which cannot be played back in such a manner that many sound sources are overlaid on top of each other as in harmony.

Further, another object of the present invention is to provide a method, an apparatus and a recording medium for playing back a sound source, which provide various effects produced by using sound sources according to a user's operations of an application (e.g. a game or the like) in the application even through a terminal which has a single sound channel or fewer sound channels than the number of the sound sources, or has a relatively low performance in processing and outputting the sound sources.

In order to accomplish these objects, there is provided an apparatus for playing back a sound source, the apparatus including: an information identification unit for identifying a type and an input time point of input sound source playback control information; a sound source selection unit for selecting a sound source corresponding to the identified type; a sound source playback point determination unit for determining a playback point of the selected sound source based on the identified input time point; and a sound source playback unit for playing back the selected sound source on and after the determined playback point.

In accordance with another aspect of the present invention, there is provided a method for playing back a sound source by an apparatus for playing back the sound source, the method including the steps of: identifying a type and an input time point of input sound source playback control information; selecting a sound source corresponding to the identified type; determining a playback point of the selected sound source based on the identified input time point; and playing back the selected sound source on and after the determined playback point.

In accordance with another aspect of the present invention, there is provided a computer-readable recording medium recording a program for executing a method for playing back a sound source, the program including the functions of: identifying a type and an input time point of input sound source playback control information; selecting a sound source corresponding to the identified type; determining a playback point of the selected sound source based on the identified input time point; and playing back the selected sound source on and after the determined playback point.

According to an embodiment of the present invention as described above, various effects produced by using sound sources according to a user's operations of an application (e.g. a game or the like) are provided in the application by using only a minimum number of sound sources.

Also, according to an embodiment of the present invention, effects similar to those, which are produced by using sound sources played back in the form of overlaying the sound sources on top of each other, are provided by selectively changing a sound source to another sound source and then playing back the changed sound source whenever sound source playback control information is input, even in an application (e.g. a mobile game) which cannot be played back in such a manner that many sound sources are overlaid on top of each other as in harmony.

Further, according to an embodiment of the present invention, various effects produced by using sound sources according to a user's operations of an application (e.g. a game or the like) are provided in the application even by a terminal which has a single sound channel or fewer sound channels than the number of the sound sources, or has a relatively low performance in processing and outputting the sound sources.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the configuration of an apparatus for playing back a sound source according to an embodiment of the present invention;

FIG. 2 is an illustrative view showing an example of playing back a sound source by an apparatus for playing back a sound source according to an embodiment of the present invention;

FIG. 3 is an illustrative view showing another example of playing back a sound source by an apparatus for playing back a sound source according to an embodiment of the present invention; and

FIG. 4 is a flowchart showing a method for playing back a sound source according to an embodiment of the present invention.

### DETAILED DESCRIPTION OF THE PREFERRED EMBODIMENTS

Hereinafter, an exemplary embodiment of the present invention will be described with reference to the accompanying drawings. It is to be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be understood that if it is described in the specification that one component is “connected,” “coupled” or “joined” to another component, a third component may be “connected,” “coupled,” and “joined” between the first and second components, although the first component may be directly connected, coupled or joined to the second component.

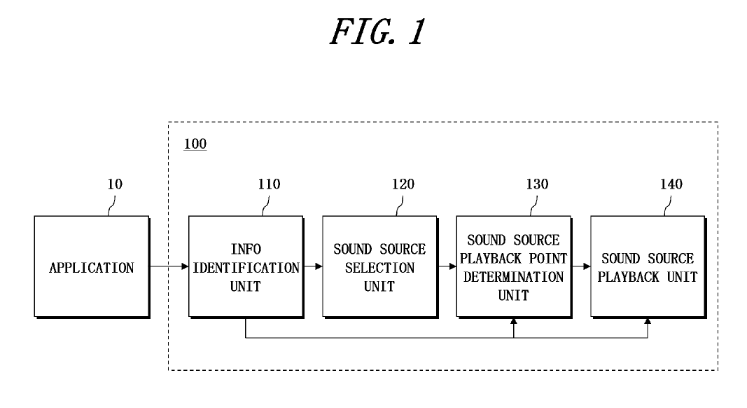

FIG. 1 is a block diagram illustrating the configuration of an apparatus 100 for playing back a sound source according to an embodiment of the present invention.

An apparatus 100 for playing back a sound source according to an embodiment of the present invention as shown in FIG. 1, which is an apparatus providing various effects produced by using sound sources, is an apparatus capable of efficiently providing various sound effects by using only a limited number of sound sources although it has a limited number of sound channels or has a poor processing performance.

To this end, the apparatus 100 for playing back a sound source according to an embodiment of the present invention includes an information identification unit 110 for receiving sound source playback control information as input and then identifying the received sound source playback control information, a sound source selection unit 120 for selecting a relevant sound source according to a result of identifying the received sound source playback control information, a sound source playback point determination unit 130 for determining a playback point of the selected sound source, and a sound source playback unit 140 for playing back the selected sound source at the determined playback point.

The information identification unit 110 identifies a type and an input time point of the input sound source playback control information.

The sound source selection unit 120 selects a sound source corresponding to the identified type of the input sound source playback control information.

The sound source playback point determination unit 130 determines a playback point of the sound source selected by the sound source selection unit 120 based on the identified input time point of the input sound source playback control information.

The sound source playback unit 140 plays back a sound source selected on and after the playback point determined by the sound source playback point determination unit 130.

The information identification unit 110 may receive, as input, sound source playback control information including an operation result of a user's operation of a particular application 10, and then identify the type of the input sound source playback control information based on the operation result included in the input sound source playback control information.

When an operation result of the user's operation of the particular application 10 corresponds to operation success or operation failure, the information identification unit 110 may identify based on the operation result whether a type of the input sound source playback control information is an operation success type or an operation failure type.

Therefore, when identifying based on the operation result included in the sound source playback control information that the type of the sound source playback control information is the operation success type, the sound source selection unit 120 selects an operation success sound source as a sound source. On the other hand, when identifying based on the operation result included in the sound source playback control information that the type of the sound source playback control information is the operation failure type, the sound source selection unit 120 selects an operation failure sound source as a sound source.

When the operation results of the user's operations of the particular application 10 are classified into at least three types, which are distinguished by scores or the like, instead of the two types including the operation success and the operation failure, the number of types of the multiple pieces of the sound source playback control information may change and that of the types of the selected sound sources may also change, depending on the number of the at least three types which are distinguished by scores or the like.

The sound source playback point determination unit 130 determines a playback point of the selected sound source corresponding to the identified input time point of the sound source playback control information based on information on the amount of playback time of the selected sound source and the identified input time point of the sound source playback control information.

Therefore, the sound source playback unit 140 plays back the selected sound source on and after the determined playback point.

Meanwhile, when the user continuously operates the particular application 10, an operation result corresponding to the user's operation is generated at each time of the user's operation. Therefore, the information identification unit 110 continuously receives, as input, sound source playback control information including the operation result generated at each time of the user's operation of the particular application 10.

Therefore, the information identification unit 110 performs a process for comparing a type of newly-input sound source playback control information with that of the previously-input sound source playback control information whenever receiving as input the new sound source playback control information following the previously-input sound source playback control information. Then, the information identification unit 110 determines whether the type of the newly-input sound source playback control information is the same as that of the previously-input sound source playback control information. Next, the sound source playback unit 140 continuously plays back a sound source which is being played back, or plays back a newly-selected sound source on and after a newly-determined playback point. The above operation will be described below in more detail.

When newly receiving as input different sound source playback control information following the previously-input sound source playback control information, the information identification unit 110 determines whether the type of the newly-input different sound source playback control information is the same as that of the previously-input sound source playback control information.

When a result of the determination shows that the type of the newly-input different sound source playback control information is the same as that of the previously-input sound source playback control information, the sound source playback unit 140 continuously plays back the sound source which has been being played back in response to the input of the previously-input sound source playback control information.

On the other hand, when the result of the determination shows that the type of the newly-input different sound source playback control information is different from that of the previously-input sound source playback control information, the sound source selection unit 120 selects another sound source corresponding to the type of the newly-input different sound source playback control information. Then, the sound source playback point determination unit 130 determines a playback point of another sound source based on an input time point of the newly-input different sound source playback control information. Therefore, the sound source playback unit 140 plays back another sound source on and after the determined playback point of another sound source.

Meanwhile, the sound source playback unit 140 plays back the selected sound source through a single sound channel (i.e. an integrated sound channel).

All sound sources to be selected by the sound source selection unit 120 are stored in a sound source database (not shown). In this case, the sound source database doesn't need to store multiple separate sound sources corresponding to multiple time points of operating sound sources (i.e. input time points of the multiple pieces of the sound source playback control information) as in the conventional apparatus for playing back a sound source. The sound source database has only to store a minimum number of sound sources the number of which corresponds to the types of operation results. For example, when the operation results are classified into the operation success and the operation failure, the sound source database has only to store two types of sounds sources including an operation success sound source and an operation failure sound source.

Also, sound sources stored in a music database may include all sound sources for producing sound effects, which are required by the particular application 10 such as a game program.

Meanwhile, the amount of execution time of the particular application 10 may be synchronized with that of playback time of sound sources corresponding to all types of multiple pieces of sound source playback control information.

The apparatus 100 for playing back a sound source according to an embodiment of the present invention as described above, which is an apparatus capable of executing application 10 installed on the apparatus and playing back a sound source, for example, may be either a mobile communication terminal (e.g. an arcade game device, a portable game device, a smart phone or the like) or a mobile terminal (e.g. a Personal Digital Assistant (PDA) or the like).

The apparatus 100 for playing back a sound source may include a single sound channel or at least two sound channels for playing back a sound source. When the apparatus 100 includes a single sound channel (i.e. an integrated sound channel), all sound sources (i.e. all sound sources selected according to the types of the multiple pieces of the sound source playback control information), which the sound source playback unit 140 plays back, may be played back through a single sound channel.

The application 10, which is installed and then executed on/by the apparatus 100 for playing back a sound source, may be any of all applications which a user can operate, and for example, may be a game program (e.g. a music game), a graphic-related program or the like.

The apparatus 100 for playing back a sound source according to an embodiment of the present invention as described above sound source can produce multiple sound effects by using only a minimum number of sound sources (e.g. the operation success sound source and the operation failure sound source).

Also, as compared with the conventional apparatus for playing back a sound source which produces various effects by overlaying many sound sources on top of each other as in harmony, the apparatus 100 for playing back a sound source according to an embodiment of the present invention can produce effects similar to those, which the above conventional apparatus produces as described above, even without overlaying the sound sources on top of each other.

Particularly, the apparatus 100 for playing back a sound source according to an embodiment of the present invention can produce various sound effects by using only a minimum number of sound sources even when the apparatus 100 has either a single sound channel or a small number of sound channels and has low processing performance.

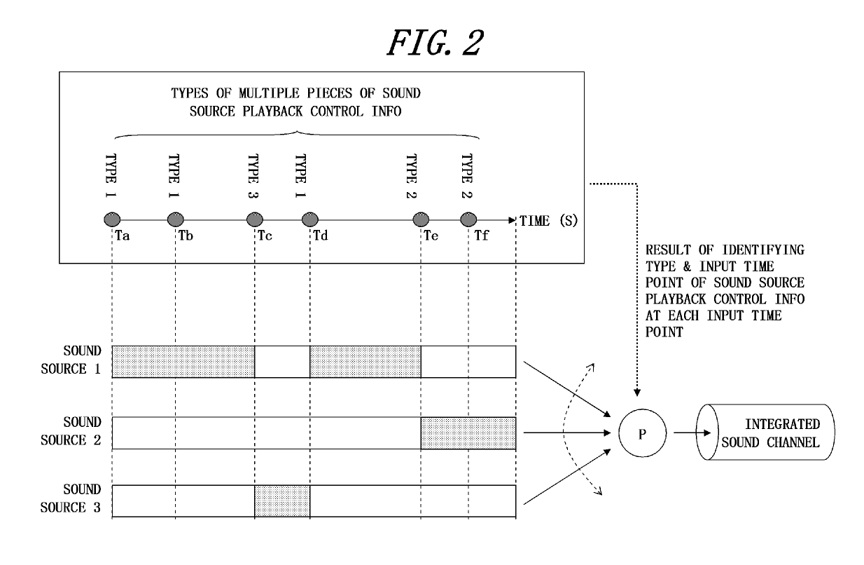

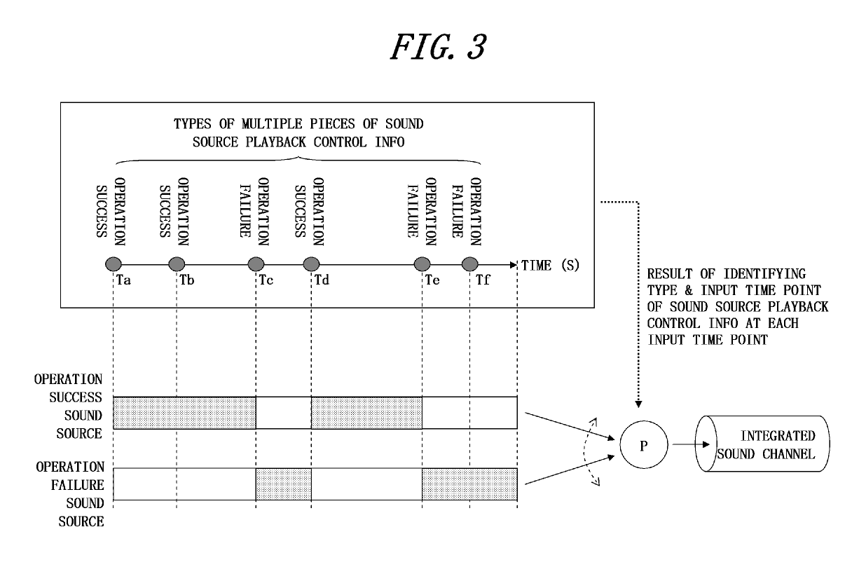

Hereinabove, the apparatus 100 for playing back a sound source according to an embodiment of the present invention has been described. Hereinafter, the apparatus 100 for playing back a sound source, which plays back sound sources and then produces various effects by using the played-back sound sources, will be illustratively described with reference to FIGS. 2 and 3.

FIG. 2 is an illustrative view showing an example of playing back a sound source by an apparatus 100 for playing back a sound source according to an embodiment of the present invention.

FIG. 2 is an illustrative view showing the playback of a sound source when the operation results of the user's operations of the particular application 10 are classified into three types, and thus, sound source playback control information, which is input to the information identification unit 110, is identified as one of the three types including type 1, type 2 and type 3.

In this case, the sound source playback apparatus 100 previously stores three sound sources (sound source 1, sound source 2 and sound source 3) corresponding to the three types of the multiple pieces of the sound source playback control information, and it is assumed that the three sound sources are all played back through a single integrated sound channel.

In FIG. 2, it is assumed that the operation results of the user's operations are classified into the three types and thus, the number of the required sound sources is 3. However, depending on the characteristics of the application 10, the operation results according to the user's operations may include two types of operation results, which include operation success and operation failure, and thus, two types of sound sources, which include an operation success sound source and an operation failure sound source corresponding to the two types of the operation results, may be included. It goes without saying that each of the number of the types of the operation results and the number of the sound sources may be at least 4.

Referring to FIG. 2, the user starts the execution of the particular application 10 at time point Ta, performs operations at time points Tb, Tc, Td, Te and Tf, and it is assumed that results of performing the operations at time points Tb, Tc, Td, Te and Tf correspond to type 1, type 3, type 1, type 2 and type 2, respectively.

Also, in an example shown in FIG. 2, it is assumed that the result of the user's operation basically corresponds to type 1 when the user starts the execution of the particular application 10. On this assumption, a sound source, which is basically played back when the user starts the execution of the particular application 10, may be set as sound source 1.

On the above assumptions, whenever each operation result is generated, the information identification unit 110 of the apparatus 100 for playing back a sound source according to an embodiment of the present invention receives as input, at each of time points Ta, Tb, Tc, Td, Te and Tf, sound source playback control information including operation result information on an operation result which is generated at each of time points Ta, Tb, Tc, Td, Te and Tf.

Therefore, the information identification unit 110 identifies input time points of multiple pieces of the input sound source playback control information as time points Ta, Tb, Tc, Td, Te and Tf, and also identifies types of the multiple pieces of the input sound source playback control information as type 1, type 1, type 3, type 1, type 2 and type 2.

As described above, after the information identification unit 110 identifies the type and the input time point of the sound source playback control information which is input at each operation time point, the sound source selection unit 120 selects a sound source corresponding to the type of the input sound source playback control information. Then, the sound source playback point determination unit 130 determines a playback point of the selected sound source.

For example, since the identified type of the sound source playback control information, which is input at time point Ta, is type 1, the sound source selection unit 120 selects sound source 1 corresponding to type 1 as a sound source to be played back by the sound source playback unit 140. Then, the sound source playback point determination unit 130 determines a playback point of sound source 1 as time point Ta based on the identified input time point Ta of the sound source playback control information which is input at time point Ta. Therefore, the sound source playback unit 140 plays back the selected sound source 1 on and after time point Ta relevant to the determined playback time point through the integrated sound channel. In FIG. 2, P represents a configuration including all of the sound source selection unit 120, the sound source playback point determination unit 130, and the sound source playback unit 140.

When receiving, as input, sound source playback control information including operation result information on the operation result of type 1 at time point Tb after time point Ta, the information identification unit 110 identifies an input time point of the received sound source playback control information as time point Tb, and identifies a type of the received sound source playback control information as type 1. At this time, since type 1 relevant to the identified type of the received sound source playback control information is the same as type 1 relevant to the type of the sound source playback control information which has previously been input at time point Ta, sound source 1, which has been being played back, is continuously played back without change.

When receiving, as input, sound source playback control information including operation result information on the operation result of type 3 at time point Tc after time point Tb, the information identification unit 110 identifies an input time point of the received sound source playback control information as time point Tc, and identifies a type of the received sound source playback control information as type 3. At this time, since type 3 relevant to the identified type of the received sound source playback control information is different from type 1 relevant to the type of the sound source playback control information, which has previously been input at time Tb, the sound source selection unit 120 newly selects sound source 3 as a sound source corresponding to type 3. Then, the sound source playback point determination unit 130 determines a playback point of the newly selected sound source 3 as time point Tc relevant to the identified input time point. Therefore, the sound source playback unit 140 plays back sound source 3 on and after time point Tc through the integrated sound channel based on the sound source playback control information which is input at time point Tc.

When receiving, as input, sound source playback control information including operation result information on the operation result of type 1 at time point Td after time point Tc, the information identification unit 110 identifies an input time point of the received sound source playback control information as time point Td, and identifies a type of the received sound source playback control information as type 1. At this time, since type 1 relevant to the identified type of the received sound source playback control information is different from type 3 relevant to the type of the sound source playback control information which has previously been input at time point Tc, the sound source selection unit 120 re-selects sound source 1 corresponding to type 1 as a sound source to be played back. Then, the sound source playback point determination unit 130 determines a playback point of the selected sound source 1 as time point Td relevant to the identified input time point. Therefore, the sound source playback unit 140 plays back sound source 1 on and after time point Td through the integrated sound channel based on the sound source playback control information which is input at time point Td.

When receiving, as input, sound source playback control information including operation result information on the operation result of type 2 at time point Te after time point Td, the information identification unit 110 identifies an input time point of the received sound source playback control information as time point Te, and identifies a type of the received sound source playback control information as type 2. At this time, since type 2 relevant to the identified type of the received sound source playback control information is different from type 1 relevant to the type of the sound source playback control information which has previously been input at time point Td, the sound source selection unit 120 newly selects sound source 2 corresponding to type 2 as a sound source to be played back. Then, the sound source playback point determination unit 130 determines a playback point of the selected sound source 2 as time point Te relevant to the identified input time point. Therefore, the sound source playback unit 140 plays back sound source 2 on and after time point Te through the integrated sound channel based on the sound source playback control information which is input at time point Te.

When receiving, as input, sound source playback control information including operation result information on the operation result of type 2 at time point Tf after time point Te, the information identification unit 110 identifies an input time point of the received sound source playback control information as time point Te, and identifies a type of the received sound source playback control information as type 2. At this time, since type 2 relevant to the identified type of the received sound source playback control information is the same as type 2 relevant to the type of the sound source playback control information which has previously been input at time point Te, sound source 2, which has been being played back, is continuously played back.

FIG. 3 is an illustrative view showing another example of playing back a sound source by an apparatus 100 for playing back a sound source according to an embodiment of the present invention.

FIG. 3 is an illustrative view showing the playback of a sound source when the operation results of the user's operations of the particular application 10 are classified into two types including operation success and operation failure, and thus, sound source playback control information, which is input to the information identification unit 110, is identified as one of the two types including the operation success and the operation failure.

In this case, the sound source playback apparatus 100 previously stores two sound sources (an operation success sound source and an operation failure sound source) corresponding to the two types of the multiple pieces of the sound source playback control information. Also, the operation success sound source may include all recorded sound sources for producing effects, which are required by the particular application 10 such as a game. Further, it is assumed that the two sound sources (the operation success sound source and the operation failure sound source) are all played back through a single integrated sound channel.

Referring to FIG. 3, the user starts the execution of the particular application 10 at time point Ta and performs operations at time points Tb, Tc, Td, Te and Tf. Also, it is assumed that results of performing the operations at time points Tb, Tc, Td, Te and Tf correspond to operation success, operation failure, operation success, operation failure and operation failure, respectively.

Further, in another example shown in FIG. 3, it is assumed that the result of the user's operation basically corresponds to the operation success when the user starts the execution of the particular application 10. On this assumption, a sound source, which is basically played back when the user starts the execution of the particular application 10, may be set as the operation success sound source.

On the above assumptions, whenever each operation result is generated, the information identification unit 110 of the apparatus 100 for playing back a sound source according to an embodiment of the present invention receives as input, at each of time points Ta, Tb, Tc, Td, Te and Tf, sound source playback control information including operation result information on an operation result which is generated at each of time points Ta, Tb, Tc, Td, Te and Tf.

Therefore, the information identification unit 110 identifies input time points of multiple pieces of the input sound source playback control information as time points Ta, Tb, Tc, Td, Te and Tf, and also identifies types of the multiple pieces of the input sound source playback control information as operation success, operation failure, operation success, operation failure and operation failure.

Since the identified type of the sound source playback control information, which is input at time point Ta, is the operation success, the sound source selection unit 120 selects the operation success sound source corresponding to the operation success as a sound source to be played back. Then, the sound source playback point determination unit 130 determines a playback point of the operation success sound source as time point Ta based on the identified input time point Ta of the sound source playback control information which is input at time point Ta. Therefore, the sound source playback unit 140 plays back the selected operation success sound source on and after time point Ta relevant to the determined playback time point through the integrated sound channel. In FIG. 3, P represents a configuration including all of the sound source selection unit 120, the sound source playback point determination unit 130, and the sound source playback unit 140.

When receiving, as input, sound source playback control information including operation result information corresponding to the operation success at time point Tb after time point Ta, the information identification unit 110 identifies an input time point of the received sound source playback control information as time point Tb, and identifies a type of the received sound source playback control information as the operation success. At this time, since the identified type of the received sound source playback control information is the same as the operation success relevant to the type of the sound source playback control information which has previously been input at time point Ta, the operation success sound source, which has been being played back, is continuously played back.

When receiving, as input, sound source playback control information including operation result information corresponding to the operation failure at time point Tc after time point Tb, the information identification unit 110 identifies an input time point of the received sound source playback control information as time point Tc, and identifies a type of the received sound source playback control information as the operation failure. At this time, since the operation failure relevant to the identified type of the received sound source playback control information is different from the operation success relevant to the type of the sound source playback control information, which has previously been input at time Tb, the sound source selection unit 120 selects the operation failure sound source corresponding to the operation failure as a sound source to be played back. Then, the sound source playback point determination unit 130 determines a playback point of the selected operation failure sound source as time point Tc relevant to the identified input time point. Therefore, the sound source playback unit 140 plays back the operation failure sound source on and after time point Tc through the integrated sound channel based on the sound source playback control information which is input at time point Tc.

When receiving, as input, sound source playback control information including operation result information corresponding to the operation success at time point Td after time point Tc, the information identification unit 110 identifies an input time point of the received sound source playback control information as time point Td, and identifies a type of the received sound source playback control information as the operation success. At this time, since the operation success relevant to the identified type of the received sound source playback control information is different from the operation failure relevant to the type of the sound source playback control information which has previously been input at time point Tc, the sound source selection unit 120 selects the operation success sound source as a sound source corresponding to the operation success. Then, the sound source playback point determination unit 130 determines a playback point of the selected operation success sound source as time point Td relevant to the identified input time point. Therefore, the sound source playback unit 140 plays back the operation success sound source on and after time point Td through the integrated sound channel based on the sound source playback control information which is input at time point Td.

When receiving, as input, sound source playback control information including operation result information corresponding to the operation failure at time point Te after time point Td, the information identification unit 110 identifies an input time point of the received sound source playback control information as time point Te, and identifies a type of the received sound source playback control information as the operation failure. At this time, since the operation failure relevant to the identified type of the received sound source playback control information is different from the operation success relevant to the type of the sound source playback control information which has previously been input at time point Td, the sound source selection unit 120 newly selects the operation failure sound source corresponding to the operation failure as a sound source to be played back. Then, the sound source playback point determination unit 130 determines a playback point of the selected operation failure sound source as time point Te relevant to the identified input time point. Therefore, the sound source playback unit 140 plays back the operation failure sound source on and after time point Te through the integrated sound channel based on the sound source playback control information which is input at time point Te.

When receiving, as input, sound source playback control information including operation result information corresponding to the operation failure at time point Tf after time point Te, the information identification unit 110 identifies an input time point of the received sound source playback control information as time point Te, and identifies a type of the received sound source playback control information as the operation failure. At this time, since the operation failure relevant to the identified type of the received sound source playback control information is the same as the operation failure relevant to the type of the sound source playback control information which has previously been input at time point Te, the operation failure sound source, which has been being played back, is continuously played back.

The conventional apparatus for playing back a sound source prepares many different sound sources according to the results of the user's operations, and provides various effects produced by using the many different sound sources played back in the form of overlaying the many prepared sound sources on top of each other. Also, to this end, the conventional apparatus for playing back a sound source requires multiple sound channels equal to the number of prepared sound sources, and requires hardware having high-performance in processing and outputting the many prepared sound sources.

However, the apparatus 100 for playing back a sound source according to an embodiment of the present invention does not need to prepare many sound sources but requires only a minimum number of sound sources (e.g. two or three sound sources) for the various effects produced by the sound sources as can be seen from an example shown in FIG. 2 and another example shown in FIG. 3. Also, the apparatus 100 for playing back a sound source according to an embodiment of the present invention provides the various effects produced by using the sound sources not in the form of overlaying the prepared sound sources on top of each other but by selecting only a minimum number of sound sources and then changing a playback point of each selected sound source, similarly to the effects produced in the form of overlaying the sound sources on top of each other. Therefore, the apparatus 100 for playing back a sound source according to an embodiment of the present invention does not require as many sound channels as sound sources, but requires only a single sound channel or a minimum number of sound channels. Namely, the apparatus 100 for playing back a sound source according to an embodiment of the present invention can provide the various sound effects by using a minimum number of sound sources without using many sound channels and hardware having high-performance.

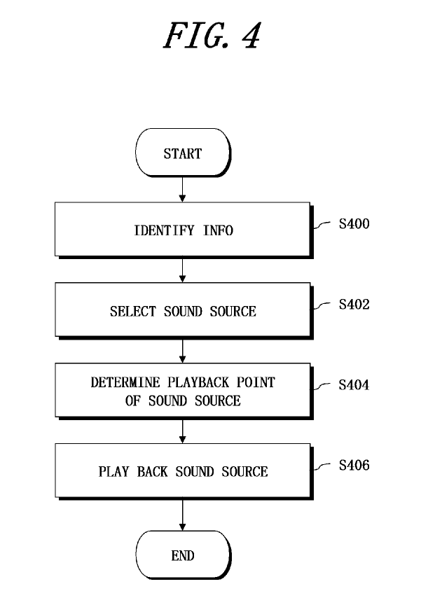

FIG. 4 is a flowchart showing a method for playing back a sound source by the apparatus 100 for playing back a sound source according to an embodiment of the present invention.

Referring to FIG. 4, a method for playing back a sound source by the apparatus 100 for playing back a sound source according to an embodiment of the present invention includes an information identification process (S400) for identifying a type and an input time point of input sound source playback control information, a sound source selection process (S402) for selecting a sound source corresponding to the identified type of the input sound source playback control information, a sound source playback point determination process (S404) for determining a playback point of the selected sound source based on the identified input time point of the input sound source playback control information, a sound source playback process (S406) for playing back the selected sound source on and after the determined playback point through the integrated sound channel, etc.

The method for playing back a sound source according to an embodiment of the present invention as described above may be implemented by a program, and may be recorded in a computer-readable recording medium.

A program recorded in a recording medium for implementing the method for playing back a sound source according to an embodiment of the present invention implements an information identification function for identifying a type and an input time point of input sound source playback control information, a sound source selection function for selecting a sound source corresponding to the identified type, a sound source playback point determination function for determining a playback point of the selected sound source based on the identified input time point, and a sound source playback function for playing back the selected sound source on and after the determined playback point through the integrated sound channel.

The computer-readable recording mediums, for example, include a ROM (Read Only Memory), a RAM (Random Access Memory), a CD-ROM (Compact Disc Read Only Memory), a magnetic tape, a floppy disc, an optical data storage device, etc. Also, the computer-readable storage mediums are distributed in a computer system connected to a network, so that computer-readable codes may be stored in the distributed storage mediums and be executed in a distributed scheme.

Further, functional programs, codes and code segments for implementing the present invention can be easily conceived by programmers in the technical field to which the present invention pertains.

According to an embodiment of the present invention as described above, various effects produced by using sound sources according to the user's operations of an application (e.g. a game or the like) are provided in the application by using only a minimum number of sound sources.

Also, according to an embodiment of the present invention, effects similar to those, which are produced by using sound sources played back in the form of overlaying the sound sources on top of each other, are provided by selectively changing a sound source to another sound source and then playing back the changed sound source whenever sound source playback control information is input, even in an application (e.g. a mobile game) which cannot be played back in such a manner that many sound sources are overlaid on top of each other as in harmony.

Further, according to an embodiment of the present invention, various effects produced by using sound sources according to a user's operations of an application (e.g. a game or the like) are provided in the application even by a terminal which has a single sound channel or fewer sound channels than the number of the sound sources, or has a relatively low performance in processing and outputting the sound sources.

Although it has been described in the above that all of the components of an embodiment of the present invention are coupled as a single unit or coupled to be operated as a single unit, the present invention is not necessarily limited to such an embodiment. That is, within the purpose of the present invention, one or more components among the components may be selectively coupled to be operated as one or more units. In addition, although each of the components may be implemented as an independent hardware, some or all of the components may be selectively combined with each other, so that they may be implemented as a computer program having one or more program modules for performing some or all of the functions combined in one or more hardwares. Codes and code segments forming the computer program can be easily conceived by an ordinarily skilled person in the technical field of the present invention. Such a computer program may implement the embodiments of the present invention by being stored in a computer-readable medium, and being read and executed by the computer. Storage mediums for storing the computer program may include a magnetic recording medium, an optical recording medium, etc.

In addition, since terms, such as “including,” “comprising,” and “having” mean that one or more corresponding components may exist unless they are specifically described to the contrary, it shall be construed that one or more other components can be further included. All of the terminologies including one or more technical or scientific terminologies have the same meanings that those having ordinary knowledge in the technical field of the present invention understand ordinarily unless they are defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those having ordinary knowledge in the technical field of the present invention will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the technical idea of the present invention is not limited by the embodiments. The protection scope of the present invention should be construed based on the accompanying claims, and it should be construed that all of the technical ideas included within the scope equivalent to the claims are included within the right scope of the present invention.

What is claimed is:

1. An apparatus for playing back a sound source, the apparatus comprising:
an information identification unit for identifying a type and an input time point of input sound source playback control information;
a sound source selection unit for selecting a sound source corresponding to the identified type;
a sound source playback point determination unit for determining a playback point of the selected sound source based on the identified input time point; and
a sound source playback unit for playing back the selected sound source on and after the determined playback point.

2. The apparatus as claimed in claim 1, wherein the information identification unit receives as an input the sound source playback control information including an operation result of a user's operation of a particular application, and identifies a type of the input sound source playback control information as an operation success type or an operation failure type based on the operation result;
the sound source selection unit selects an operation success sound source as the sound source when the information identification unit has identified based on the operation result that the type of the input sound source playback control information is the operation success type; and
the sound source selection unit selects an operation failure sound source as the sound source when the information identification unit has identified based on the operation result that the type of the input sound source playback control information is the operation failure type.

3. The apparatus as claimed in claim 1, wherein the sound source playback point determination unit determines the playback point corresponding to the identified input time point based on information on an amount of playback time of the selected sound source and the identified input time point.

4. The apparatus as claimed in claim 1, wherein the information identification unit determines whether a type of newly-input different sound source playback control information is equal to the type of the previously-input sound source playback control information when newly receiving as an input the different sound source playback control information following the previously-input sound source playback control information;
the sound source playback unit continuously plays back the sound source which has been being played back in response to the input of the previously-input sound source playback control information when a result of the determination shows that the type of the newly-input different sound source playback control information is equal to the type of the previously-input sound source playback control information; and
when the result of the determination shows that the type of the newly-input different sound source playback control information is different from the type of the previously-input sound source playback control information, the sound source selection unit selects another sound source corresponding to the type of the newly-input different sound source playback control information, the sound source playback point determination unit determines a playback point of another sound source based on an input time point of the newly-input different sound source playback control information, and the sound source playback unit plays back another sound source on and after the determined playback point of another sound source.

5. The apparatus as claimed in claim 1, wherein the sound source playback unit plays back the selected sound source through a single sound channel.

6. A method for playing back a sound source by an apparatus for playing back the sound source, the method comprising the steps of:
identifying a type and an input time point of input sound source playback control information;
selecting a sound source corresponding to the identified type;
determining a playback point of the selected sound source based on the identified input time point; and
playing back the selected sound source on and after the determined playback point.

7. A computer-readable recording medium recording a program for executing a method for playing back a sound source, the program comprising the functions of:
identifying a type and an input time point of input sound source playback control information;
selecting a sound source corresponding to the identified type;
determining a playback point of the selected sound source based on the identified input time point; and
playing back the selected sound source on and after the determined playback point.
